(19) United States
(12) Patent Application Publication
(10) Pub. No.: US 2024/0355228 A1
(43) Pub. Date: Oct. 24, 2024

(54) SYSTEM FOR ADVANCED PHYSICIAN TRAINING AND PATIENT SPECIFIC REHEARSALS

(71) Applicant: BIOMODEX, S.A.S., Paris (FR)

(72) Inventors: Pierre-Benoit PIRLOT, Paris (FR); Pierre BRÉGEARD, Paris (FR)

(21) Appl. No.: 18/681,424

(22) PCT Filed: Jul. 23, 2022
(86) PCT No.: PCT/IB2022/056817

§ 371 Date: Feb. 5, 2024

Related U.S. Application Data
(63) Continuation-in-part of application No. 16/333,872, filed on Mar. 15, 2019, now Pat. No. 10,976,722.
Application No. 16/333,872 is a continuation-in-part of application No. 16/333,721, filed on Mar. 15, 2019, now Pat. No. 11,169,504.
Application No. 16/333,721 is a continuation-in-part of application No. 16/417,151, filed on May 20, 2019, now abandoned.
(60) Provisional application No. 63/225,547, filed on Jul. 25, 2021.

(51) Int. Cl. G09B 23/28; G09B 23/30

(52) U.S. Cl. CPC G09B 23/285; G09B 23/303

(57) ABSTRACT

A surgical training and rehearsal system includes a valve and a pump fluidically coupled with the valve. A tank for storing a fluid is fluidically coupled with the valve. A surgical approach tube having a proximal end sealingly covered by self-healing elastomeric membrane is fluidically coupled with the valve. An exit port is fluidically coupled with a distal end of the surgical approach. An anatomical access cartridge is removably coupled with the exit port has a tortuous path whose shape, size and mechanical properties mimic those of a human blood vessel selected from the group aortic arch, radial artery, and femoral artery. An anatomical cartridge is removably coupled with the anatomical access cartridge and has a tortuous path whose shape, size and mechanical properties mimic those of a human blood vessel selected from the group subclavian artery, common carotid artery, and cerebral artery.

### PRIORITY AND INCORPORATION BY REFERENCE

This application claims priority to and incorporates by reference U.S. Application No. 63/225,547, filed Jul. 25, 2021 which claims priority to and incorporates U.S. application Ser. No. 16/333,872 filed 15 Mar. 2019, and U.S. application Ser. No. 16/333,721 (PCT/IB2016/001500 filed 19 Sep. 2016, PCT publication WO2018051162A1) filed 15 Mar. 2019 entitled Method and Apparatus for Generating A 3D Model of An Object, and U.S. application Ser. No. 16/333,872 (PCT/EP2017/073621 filed 19 Sep. 2017, PCT publication WO2018050915A1) filed Mar. 15, 2019 entitled Method for Fabricating A Physical Simulation Device, Simulation Device, Simulation System, U.S. application Ser. No. 16/417,151 (PCT/IB2019/054160 filed 20 May 2019, PCT publication WO2019224700A1) filed 20 May 2019 entitled Echogenic Organ Replica and Method of Manufacture Using an Additive Manufacturing System.

### BRIEF DESCRIPTION OF THE DRAWINGS

FIG. 1 shows an example patient simulation system including a housing, anatomical access cartridge, anatomical cartridge, and mat;

FIG. 2 is a component level view of the patient simulation system;

FIGS. 3A-3D show examples of the anatomical access cartridge;

FIGS. 4A-4C are views of the housing and components thereof;

FIGS. 5A-5B show the access for the surgical approach and filter;

FIGS. 5C-5D show the clot insertion port;

FIGS. 5E-5G show the clot cartridge and clot cartridge locking mechanism;

FIG. 6 shows the direction of circulation in the system and the return line;

FIGS. 7A-7C show how the mat is removably coupled with the housing;

FIG. 8 is an enlarged view of an anatomical cartridge;

FIG. 9-1 and FIG. 9-2 are representations of a surgical training and rehearsal system;

FIG. 10-1 through FIG. 10-3 are representations of fluid paths through the surgical training and rehearsal system;

FIG. 11 is a flowchart of a method for assembling a surgical training and rehearsal system; and

FIG. 12 is a flowchart of a method for operating a surgical training and rehearsal system.

### DETAILED DESCRIPTION

Disclosed is an innovative approach for advanced physician training and patient specific rehearsals. The patient simulation system disclosed herein provides critical tactile feedback to physicians rehearsing a surgical procedure. The patient simulation system is specifically adapted for use with 3D printed anatomical cartridges which reproduce the anatomy of at least a portion of anatomy. By manner of example, the 3D printed anatomical cartridges can include a 3D model of an intracranial aneurism. The 3D printed anatomical cartridges is formed of a combination of materials to provide desired mechanical behavior, X-ray compatibility, realistic fluoroscopic images. See, U.S. application Ser. No. 16/333,872 filed 15 Mar. 2019, U.S. application Ser. No. 16/333,721 (PCT/IB2016/001500 filed 19 Sep. 2016, PCT publication WO2018051162A1) filed 15 Mar. 2019 entitled Method and Apparatus for Generating A 3D Model of An Object, U.S. application Ser. No. 16/333,872 (PCT/EP2017/073621 filed 19 Sep. 2017, PCT publication WO2018050915A1) filed Mar. 15, 2019 entitled Method for Fabricating A Physical Simulation Device, Simulation Device, Simulation System, and U.S. application Ser. No. 16/417,151 (PCT/IB2019/054160 filed 20 May 2019, PCT publication WO2019224700A1) filed 20 May 2019 entitled Echogenic Organ Replica and Method of Manufacture Using an Additive Manufacturing System.

The patient simulation system is intended for use in a cathlab, and features a simulated systemic (circulatory?) flow using a fluid replicating blood density and viscosity. In addition to the anatomical cartridges, the patient simulation system includes anatomical access cartridges used to simulate an aortic arch, a radial artery approach (right or left hemisphere), a femoral artery approach, and an ischemic approach. In some embodiments, the anatomical cartridges and/or the anatomic access cartridges are generic, i.e., patient agnostic. In some embodiments, the anatomical cartridges and/or the anatomic access cartridges mimic the unique anatomy of a patient (patient specific).

The generic anatomical cartridges and/or anatomic access cartridges may, for example, be used for training purposes. In some embodiments, the patient-specific cartridges, created from scans of the patient, are used to rehearse a specific endoluminal procedure. Difficulties encountered in a simulation using the patient-specific cartridges represent real-world challenges that the surgeon may encounter when performing the endoluminal procedure on the patient.

Separating the anatomical cartridge from the access cartridge (e.g., utilizing a separate anatomical cartridge and access cartridge) enables a physician maximum flexibility to select the appropriate anatomy and the anatomical access. The anatomical cartridge and the anatomical access cartridge each utilize a standard sized frame which enables plug-and-play replacement of cartridges.

The patient-specific cartridges may be created from one or more of CT images, MRI images, and 3D angiography of a patient's unique anatomy. In the context of an aneurism procedure, the patient simulation system may be used to rehearse commonly used medical procedural methods, such as flow diversion, coil embolization, balloon-assisted coil embolization, stent placement, and intravascular device placement.

In the context of an ischemic procedure, the patient simulation system may be used to rehearse clot removal by using commonly used clot removal methods, such as thrombo-aspiration and stent retriever. The patient simulation system is compatible with (e.g., may help to simulate) both natural and artificial clots. Natural clots may include clots made from actual blood, such as human blood, porcine blood, or bovine blood. Artificial clots may made from substances other than blood.

In some embodiments, the patient simulation system provides a mechanism that allows the healthcare provider to observe the amount of clot that embolizes distally during the ischemic procedure. The patient simulation system may use a filter placed distally to the outflow of the cartridge to collect the formed clots. In some embodiments, the system includes a window that allows the physician to the contents of the filter, such as view debris captured by the filter without interrupting the simulated surgical procedure.

In some embodiments, the clot is inserted directly into the anatomical cartridge using a needle or the like. In other examples, a clot cartridge includes a cartridge which has been pro-loaded with a clot. The clot cartridge may be loaded into the patient simulation system to introduce the clot into the patient simulation system. In some examples, the clot cartridge is interposed between the anatomical cartridge and the anatomical access cartridge. The clot cartridge may provide plug-and-play functionality, allowing the physician, technician, administrator, or other operator to add additional clots during a simulated procedure.

In some embodiments, the patient simulation system is equipped with a port covered by a self-healing membrane through which clots may be inserted on-the-fly, i.e., without disrupting the flow of fluid. The port may be located at a proximal end of the surgical approach tube. By covering the port with a self-healing membrane, a surgical or other instrument may be inserted into the proximal end of the surgical approach tube. The self-healing membrane may mimic the physical properties of the user's skin and/or blood vessels, including puncture resistance, puncture pressure, and so forth. When the instrument is removed from the proximal end of the surgical approach tube, the self-healing membrane may seal over the puncture, thereby preventing fluid at the proximal end of the surgical approach tube from exiting the proximal end of the surgical approach tube.

The surgical training and rehearsal system may further include an exit port. The exit port may be located at the distal end of the surgical approach tube. The exit port may be connected to the anatomical access cartridge. The exit port may form a sealed connection between the distal end of the surgical approach tube and the anatomical access cartridge.

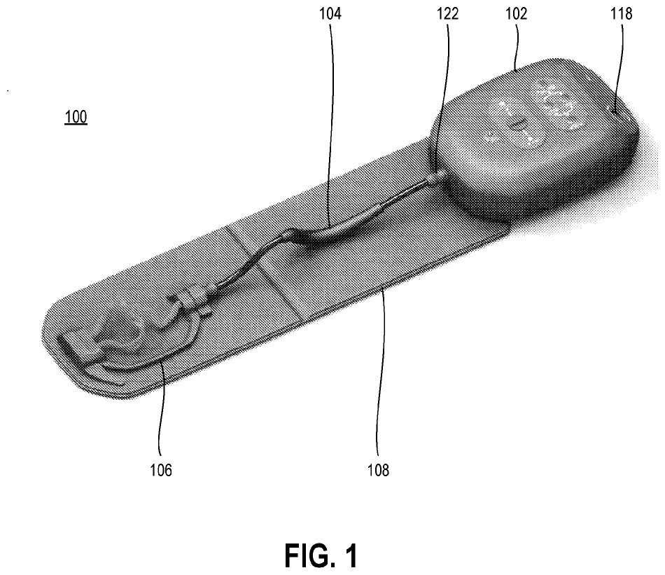

FIG. 1 shows an example surgical training and rehearsal system 100 including a housing 102, anatomical access cartridge 104, anatomical cartridge 106, and mat 108.

In some examples, one or more of the anatomical cartridge 106 and the anatomical access cartridge 104 may be provided with a magnet and/or ferromagnetic material magnetically attracted to another magnet and/or ferromagnetic material provided in the mat 108. The magnetic attraction between the anatomical cartridge 106 and the anatomical access cartridge 104 may allow the anatomical cartridge 106 and/or anatomical access cartridge 104 to snap into a desired orientation. The magnetic connection may further help to resist misorientation relative to the mat 108. For example, the polarity of the magnets, and the respective magnetic attraction and repulsion based on the polarity of the magnets, may cause the anatomical access cartridge 104 and/or the anatomical cartridge 106 to rotate when placed next to each other. One or more magnets or ferromagnetic material may be provided in a base of the anatomical cartridge 106, anatomical access cartridge 104 and/or on proximal and/or distal ends of the anatomical cartridge 106, anatomical access cartridge 104. One or more magnets or ferromagnetic material may be provided in the mat 108 proximal a corresponding location in the anatomical cartridge 106, anatomical access cartridge 104. As the anatomical access cartridge 104 and the anatomical cartridge 106 are brought close to each other, magnetic attraction between the respective magnetics may result in the anatomical access cartridge 104 and the anatomical cartridge 106 being magnetically secured to each other. The magnets may help to secure and/or orient the anatomical cartridge 106 and/or the anatomical access cartridge 104 to the mat 108 and the housing 102.

In some embodiments, the anatomical access cartridge 104 and the mat 108 may be magnetically connected to each other. For example, the anatomical access cartridge 104 and the mat 108 may include complementary magnets. The respective magnets on the anatomical access cartridge 104 and the mat 108 and be magnetically attracted to each other. As the anatomical access cartridge 104 is placed on the mat 108, the magnetic attraction may cause the anatomical access cartridge 104 and the mat 108 to snap into place and be magnetically connected.

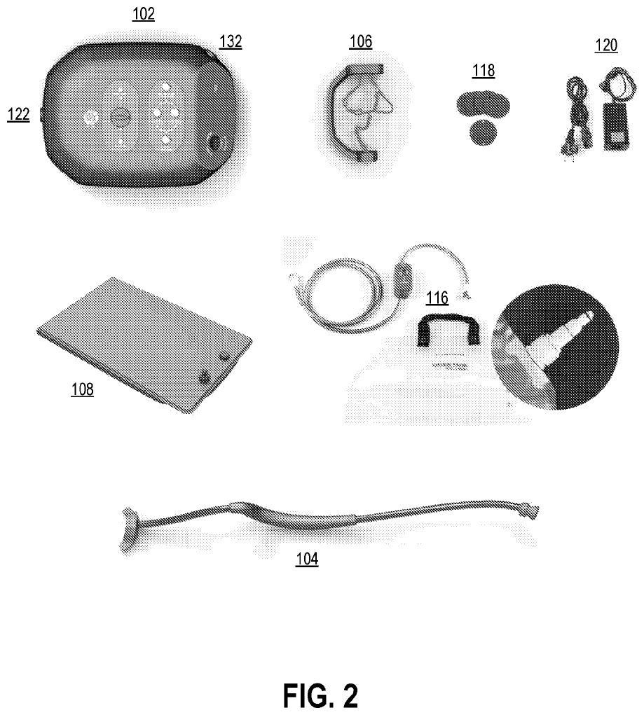

FIG. 2 is a component level view of the system of FIG. 1 and depicts the housing 102, anatomical cartridge 106, mat 108, flush tube and bag 116, membrane 118, power supply 120, outflow port 122, and drain port 132.

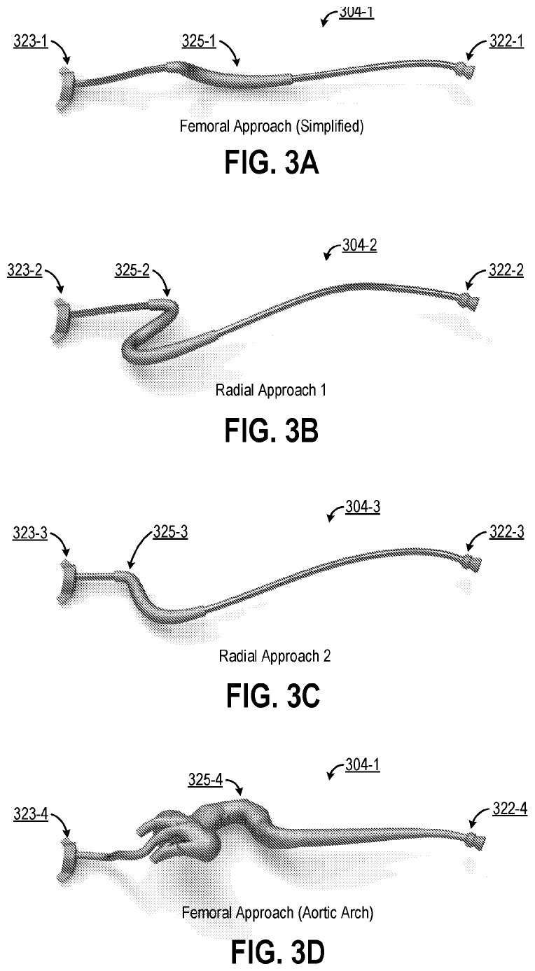

FIG. 3A through FIG. 3D shows various example anatomical access accessories (collectively 304) for simulating a radial artery approach (right or left hemisphere), a femoral artery approach, and an ischemic approach during a simulated procedure. The depictions are purely examples and are not intended to be limiting. As discussed herein, the anatomical access accessory 304 is interposed between and fluidically connects an outflow port (collectively 322) on the housing with an anatomical cartridge connector (collectively 323). A vascular section (collectively 325) of the anatomical access accessory 304 may simulate a geometry of an artery, vein, or other vascular section. As discussed herein, the vascular section may be based on a generic, patient-agnostic vasculature. In some embodiments, the vascular section is patient-specific, or is based on a 3D model of a patient's vasculature.

As may be seen, the anatomical access accessory 304 may simulate the shape of a patient's vasculature commonly used as an approach to a target location. For example, FIG. 3A shows a first anatomical access accessory 304-1 having a first vascular section 325-1 located between a first outflow port 322-1 and a first anatomical cartridge connector 323-1. As may be seen, the first vascular section 325-1 has a shape that is representative of a simplified femoral artery approach.

FIG. 3B shows a second anatomical access accessory 304-2 having a second vascular section 325-2 located between a second outflow port 322-2 and a second anatomical cartridge connector 323-2. As may be seen, the second vascular section 325-2 has a shape that is representative of a radial artery approach.

FIG. 3C shows a third anatomical access accessory 304-3 having a third vascular section 325-3 located between a third outflow port 322-3 and a third anatomical cartridge connector 323-3. As may be seen, the third vascular section 325-3 has a shape that is representative of a radial artery approach.

FIG. 3D shows a fourth anatomical access accessory 304-4 having a fourth vascular section 325-4 located between a fourth outflow port 322-4 and a fourth anatomical cartridge connector 323-4. As may be seen, the fourth vascular section 325-4 has a shape that is representative of an aortic arch femoral artery approach.

The external appearance of the anatomical access accessory 304 as well as the anatomical cartridge 106 may or may not mimic the appearance of similar organs on the human body. The anatomical access accessory 304 and the anatomical cartridge 106 are both hollow three-dimensional structures having a lumen whose size, geometry, internal resistance and mechanical characteristics match those of corresponding organs in the human body. This is because the surgical training and rehearsal system 100 is intended to provide the same tortuous path, mechanical characteristics, and resistance as encountered by the physician during endoluminal navigation. A tortuous path may be a non-straight path. Human vasculature is rarely oriented in a straight line. The anatomical access accessory 304 and/or the anatomical cartridge 106 may be formed with a tortuous path to mimic the curves, deviations, branches, and other non-straight features of the vasculature. In the case of a patient-specific anatomical cartridge 106 and/or patient-specific anatomical access accessory 304 the interior geometry will precisely mimic the interior geometry of corresponding organs of the patient. The materials used to print the anatomical access accessory 304 and the anatomical cartridge 106 mimic the mechanical properties of tissue and provide very realistic feedback to the physician.

The system of the present disclosure is compatible with X-ray imaging to allow real time navigation with fluoroscopy. The system of the present invention mimics the real-world experience that the surgeon will encounter. More particularly, the system uses materials selected to avoid providing unrealistically good contrast and without artifacts that the surgeon would not expect to encounter during the actual endoluminal procedure. More particularly, the mat, anatomical access cartridge, anatomical cartridge, and return tube are all constructed of X-ray compatible materials. More particularly, the materials utilized have low-X-ray absorption (e.g., the materials may be transparent to X-rays). By manner of illustration, the surgical training and rehearsal system 100 may utilize polymeric materials. The anatomical cartridge and the anatomical access cartridge utilize materials which provide the same or similar contrast (visualization experience) as the native anatomical organs. In contrast, the surgical training and rehearsal system 100 is constructed to minimize X-ray artifacts and the like which the user would not experience in the actual endoluminal procedure. The system is compatible with contrast agent such as iodine used to highlight the lumen during navigation.

The solution described aims to simulate unruptured aneurysm embolization and ischemic stroke procedures in real clinical conditions. Without limiting the disclosure, such conditions may include:
Realistic dimensions of the vasculature
Realistic tortuosity of the vasculature
Realistic physiological environment, such as temperature, flow, pressure, viscosity, and combinations thereof
Usage of fluoroscopy for navigating inside the patient

The complexity of the simulated procedure uses the anatomical topology of the patient case. The surgical training and rehearsal system 100 presents the doctor and/or health care provider with the same or similar visualization experience as surgery and hence. In some embodiments, the surgical training and rehearsal system 100 may not facilitate direct viewing using transparent arteries or transparent organs.

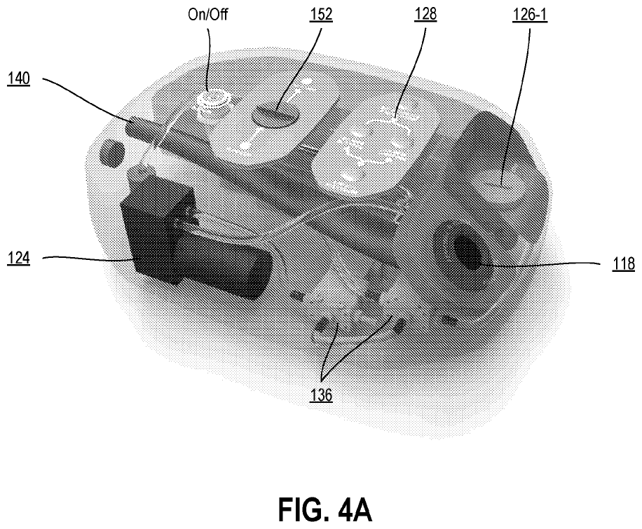

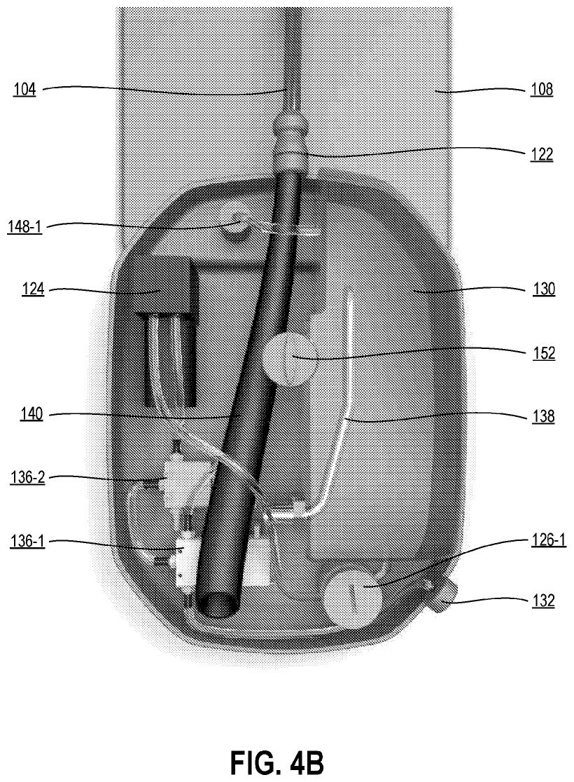

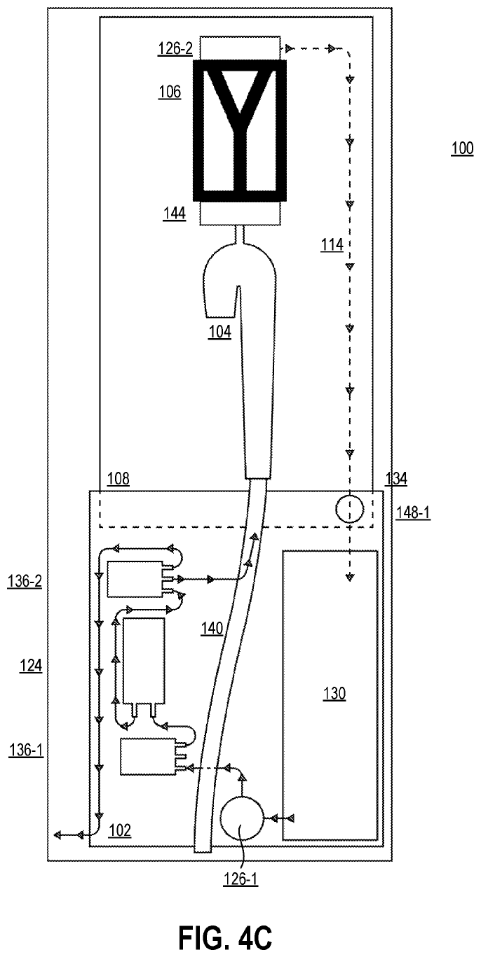

FIGS. 4A and 4B show an interior of an example housing 102. The housing 102 contains a membrane 118, a pump 124, a first filter 126-1, an electronics assembly 128, a tank 130 for storing a fluid, a drain port 132, solenoid valves 136-1, 136-2, heater 138, approach 140, a flow controller 152. The housing 102 may be connected to an anatomical access cartridge 104 at an outflow port 122. The housing 102 and/or the anatomical access cartridge 104 may be supported by a mat 108.

As best seen in FIG. 4A, the membrane 118 may be a self-healing membrane. The self-healing membrane may cover the proximal end of the surgical approach tube. For example, the self-healing membrane may cover an entirety of the proximal end of the surgical approach tube such that the self-healing membrane may seal the proximal end of the surgical approach tube. For example, the self-healing membrane may seal holes after they are punctured and the instrument removed. In some embodiments, the self-healing membrane may include an elastomeric member. In some embodiments, the self-healing membrane may include any self-healing material. The membrane 118 may cover a proximal end of the approach 140. The membrane 118 provides the surgeon with an access point for accessing the approach 140 with surgical tools and implants used in the endoluminal procedure and is intended to mimic the resistance of accessing a human blood vessel with a surgical tool. The approach 140 extends the length of the housing 102. At a distal end of the approach 140, the approach 140 is fluidically coupled with the outflow port 122. Put another way, the outflow port 122 is located at a distal end of the approach 140. The anatomical access cartridge 104 may be connected to the distal end of the approach 140 at the outflow port 122. The anatomical cartridge 106 may be connected to the anatomical access cartridge 104

FIG. 4C is schematic representation of the surgical training and rehearsal system 100. As may be seen, the approach 140 may be connected to a anatomical access cartridge 104 and a anatomical cartridge 106. Blood mimicking fluid may flow from a tank 130 to a first filter 126-1 and through a first solenoid valve 136-1. The blood mimicking fluid may be pumped using a pump 124. The pump 124 may pull the blood mimicking fluid from the tank 130 and to the first filter 126-1. Fluid inflow from the tank 130 may be controlled using the first solenoid valve 136-1.

The blood mimicking fluid may flow out of the pump 124 and into a second solenoid valve 136-2. The second solenoid valve 136-2 may include multiple outlets. For example, the solenoid valves 136-1, 136-2 may direct the blood mimicking fluid to the approach 140. In this manner, as the surgeon, physician, or other health care provider may experience hydraulic conditions in the anatomical access cartridge 104 and/or the anatomical cartridge 106 that mimic the hydraulic conditions inside a patient. In some embodiments, the second solenoid valve 136-2 may direct excess blood mimicking fluid to a drain port 132.

The blood mimicking fluid may pass from the anatomical access cartridge 104 and into the anatomical cartridge 106 through a clot insertion port 144. A second filter 126-2 may return to the tank 130 through a return path 114. The return path 114 may be connected to the tank 130 with an inflow port 134. In this manner, the blood mimicking fluid may be recycled throughout the simulated procedure.

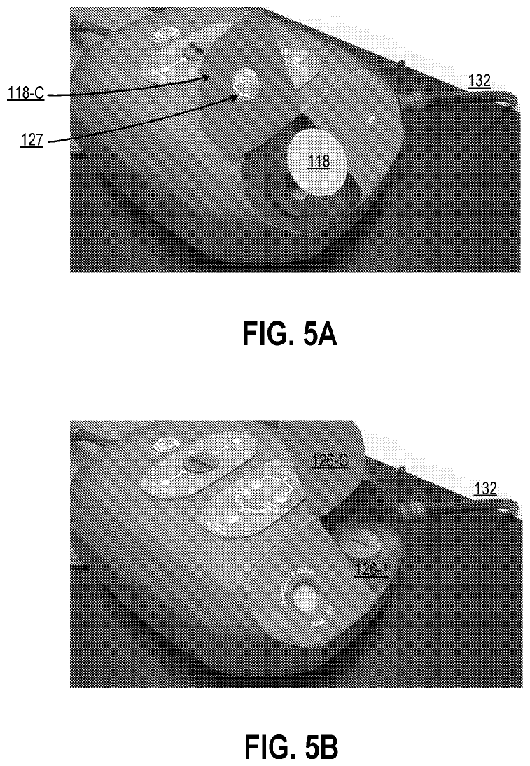

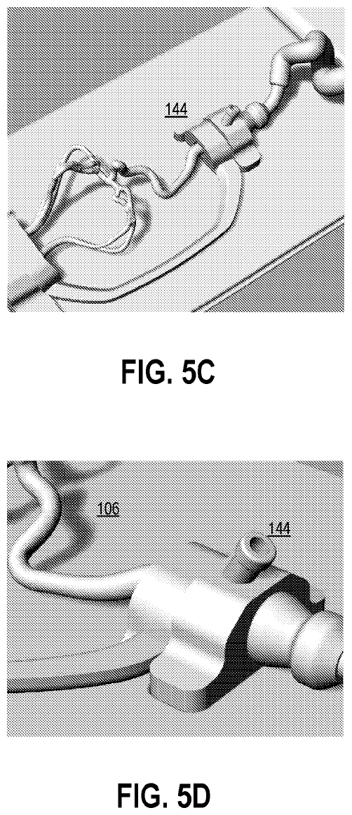

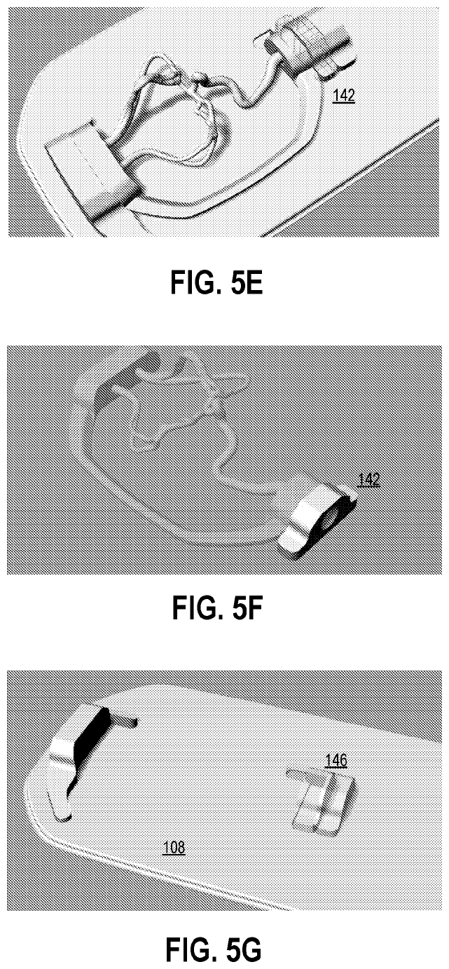

In some embodiments, the membrane 118 is replaceable. As best seen in FIG. 5A, a hatch 118C provides access to replace the membrane 118. Hatch 118C may include an access port 127 through which the physician accesses the membrane 118 with surgical tools. A fill port may be fluidically coupled with the tank 130 and used to fill the tank 130 for storing the fluid.

Drain port 132 may be used to drain fluid from the tank 130 for storing the fluid. In use, the flush bag 116 (as may be seen in FIG. 2) may be fluidically coupled with the drain port to collect fluid discharged from the tank 130 for storing the fluid.

The surgical training and rehearsal system 100 may include a heater 138 provided in the tank 130 to maintain the fluid at a desired temperature, e.g., the approximate temperature of the human body, 100 degrees Fahrenheit (37 Celsius). The electronics assembly 128 supplies power to and controls the operation of the heater 138, pump 124, and solenoid valves 136-1, 136-2. In some examples, the electronics assembly 128 is used to adjust the flow rate of the pump 124.

FIG. 5B shows hatch 126C used to access the first filter 126-1 which filters the fluid before it enters the first solenoid valve 136-1. In the direction of fluid flow, the fluid exits the housing via outflow port 122 and enters the anatomical access cartridge.

Turing once again to FIG. 4C, surgical training and rehearsal system 100 features a clot insertion area which may for example be provided between the anatomical access cartridge 104 and the anatomical cartridge 106. FIGS. 5C and 5D illustrate a clot insertion port 144 through which a clot may be inserted using a syringe or the like. The clot insertion port 144 may be fluidically coupled to and upstream from the anatomical cartridge 106 such that clots inserted into the port 144 will lodge in the anatomical cartridge 106. The clot insertion port 144 features a self-healing membrane to prevent the leakage of fluid during and after the port 144 is accessed by a syringe to insert the clot.

FIG. 5E through FIG. 5G illustrate the use of a clot cartridge 142 which is a cartridge which has been pre-loaded with a clot. As may be seen in FIG. 5E and FIG. 5F, the clot cartridge 142 is operatively coupled to the anatomical cartridge 106. FIG. 5G illustrates an adjustable locking feature 146 which slidably adjusts between first, second and third positions. In the first position, the adjustable locking feature 146 is fully extended to allow insertion/removal of the anatomical cartridge 106 alone and/or the anatomical cartridge 106 combined with the clot cartridge 142. In the second position. In the second position, the adjustable locking feature 146 engages with and locks the anatomical cartridge 106 and the clot cartridge 142 in place to prevent leaks. In the third position, the adjustable locking feature 146 engages with and locks the anatomical cartridge 106 (without the clot cartridge 142) in place to prevent leaks.

As depicted in FIG. 4C, the surgical training and rehearsal system 100 may include an optional second filter 126-2 external to the housing and in-line with the return path of fluid exiting the anatomical cartridge 106. The purpose of providing second filter 126-2 is to enable the physician to quickly and easily visualize any clot debris generated during clot removal process. In some examples, the surgical training and rehearsal system 100 includes a transparent window such that the physician can view the contents of the filter, such as debris captured by the filter without interrupting the system. In some examples, the transparent window includes a magnifying lens to enlarge the contents of the filter, including any debris captured by the filter. For example, the contents of the filter may include clotted blood mimicking fluid. In some examples, the contents of the filter may include clotted actual blood. In some embodiments, the contents of the filter may include precipitates from the blood mimicking fluid. In some embodiments, the contents of the filter may include any other contaminants introduced into the blood mimicking fluid. In some embodiments, the transparent window may be located on an exterior of the housing 102. In some embodiments, the transparent window may be located on an upper surface of the housing 102. In some embodiments, the transparent window may be located anywhere on the housing 102 to allow the user to view the contents of the filter.

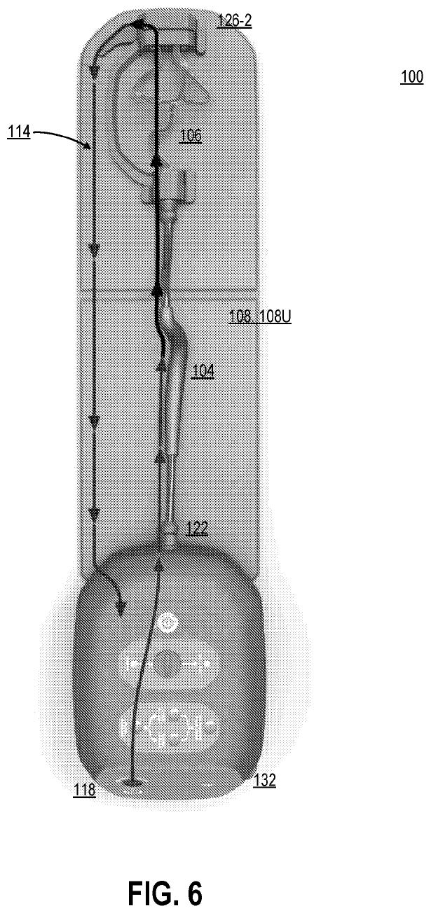

FIG. 6 shows the circulatory flow of fluid through the surgical training and rehearsal system 100. Return path 114 may be at least partially embedded or housed within the mat 108 or may be provided on either an upper surface 108U of the mat 108 which is visible to the user or lower surface of the mat which is not visible to the user. Return path 114 terminates with coupler 108-1 (as may be seen in FIG. 2) which is removably coupled with inflow port 134 (as may be seen in FIG. 4C). The inflow port 134 may be, in turn, fluidically coupled with the tank 130 for storing the fluid. In some examples, the inflow port 134 is located on the underside of the housing 102 such that when the housing 102 is placed on the mat 108, the inflow port 134 engages coupler 108-1 (as may be seen in FIG. 2) which is fluidically coupled the return path 114.

In the examples depicted in FIG. 4A-4C, two solenoid valves are used to control circulation of the fluid and/or drain the fluid. One of ordinary skill in the art will appreciate that a single solenoid valve may be used or that the solenoid valve(s) may be replaced with one or more mechanically actuated valves.

A power supply 120 (as may be seen in FIG. 2) may be removably attached to the housing 102 and supply power to the electronics assembly 128.

A flush tube and bag 116 (as may be seen in FIG. 2) may removably connect to the drain port 132. In operation, the surgical training and rehearsal system 100 may be flushed by attaching the flush tube and bag 116 to the drain port 132 (as may be seen in FIG. 5B), and then manually or electronically setting the solenoid valve 136 into the first position, and actuating the pump 124.

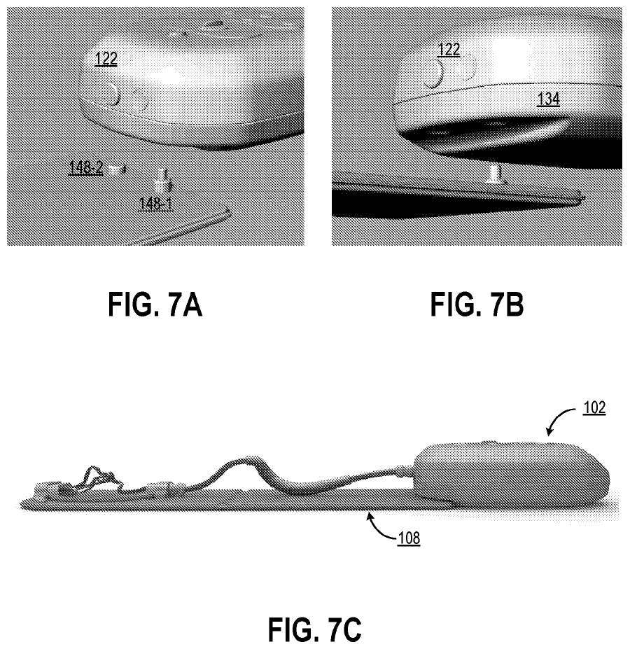

FIG. 7A-C show another example of how the inflow port 134 may be coupled with the return path 114. In FIG. 7A and 7B, the housing is equipped with two studs 148-1, 148-2 which mattingly engage with corresponding recesses 150-1, 150-2 in mat 108. One of the studs 148-1, 148-2 and a corresponding one of the recesses 150-1, 150-2 are fluidically coupled with the return path 114, the other one of the studs 148-1, 148-2 and a corresponding one of the recesses 150-1, 150-2 are provided to avoid rotation of the housing 102 relative to the mat 108. In FIG. 7C, the housing 102 has been secured to the mat 108.

For example, one of the housing and the mat includes a first stud 148-1. The other of the housing and the mat includes a first recess 150-1. The first recess 150-1 is configured to engage with the first stud 148-1 (e.g., the first stud 148-1 is configured to be inserted into the first recess 150-1). In some embodiments, the first stud 148-1 and the first recess 150-1 fluidically couple the tank 130 to the return path 114. As may be seen, one of the housing and the mat includes a second stud 148-2. The other of the housing and the mat includes a second recess 150-2. The second stud 148-2 may be configured to engage with the second recess 150-2 (e.g., the second stud 148-2 is configured to be inserted into the second recess 150-2). In some embodiments, the first stud 148-1 inserted into the first recess 150-1 and the second stud 148-2 inserted into the second recess 150-2 may prevent the housing from rotating with respect to the mat. Preventing the housing from rotating with respect to the mat may help to maintain the housing and the mat in position.

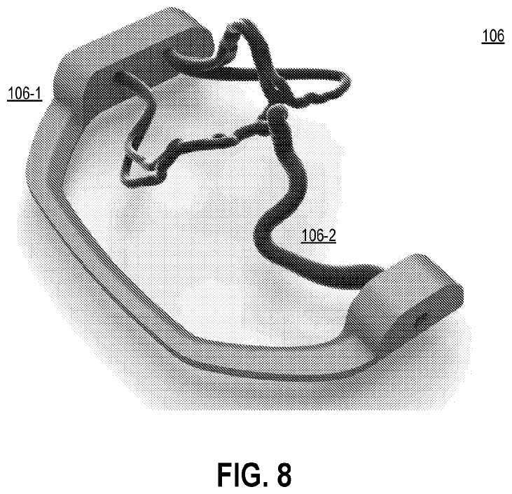

FIG. 8 is an enlarged view of an anatomical cartridge 106. The anatomical cartridge includes a frame 106-1 which does not form part of the anatomy and whose purpose is merely to support the anatomical portion 106-2. The anatomical portion 106-2 includes at least one tortuous path having a lumen whose shape, size and mechanical properties mimic those of a human blood vessel selected from the group subclavian artery, common carotid artery, and cerebral artery. As discussed herein, a tortuous path may be a non-straight path. For example, the tortuous path may include one or more changes in diameter, direction, orientation, any other change in shape or path, and combinations thereof.

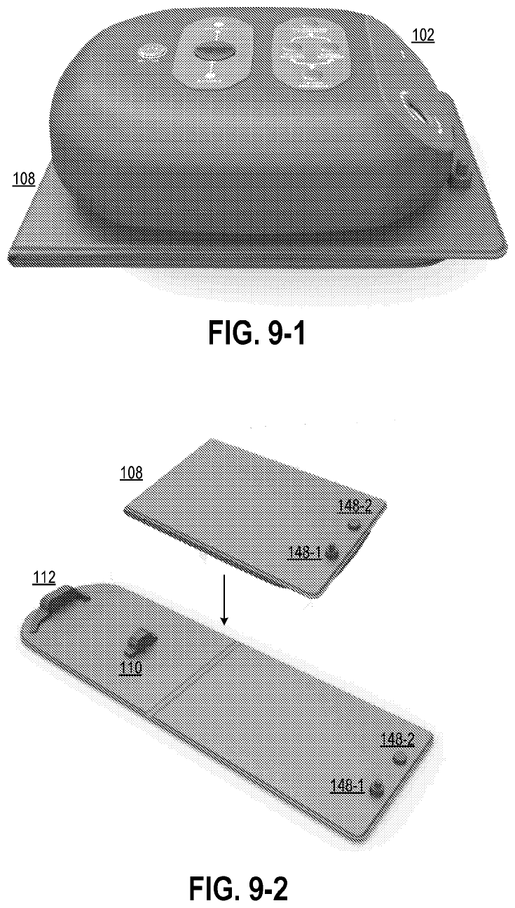

FIG. 9-1 is a representation of a housing 102 located on a mat 108. In FIG. 9-1, the mat 108 is folded over on itself in a storage position. In FIG. 9-2, the mat 108 is unfolded into the operational position, with the studs 148-1, 148-2, a cartridge front support 110 and a cartridge rear support 112. In this manner, the housing 102 and the mat 108 may be easily and compactly stored and transported.

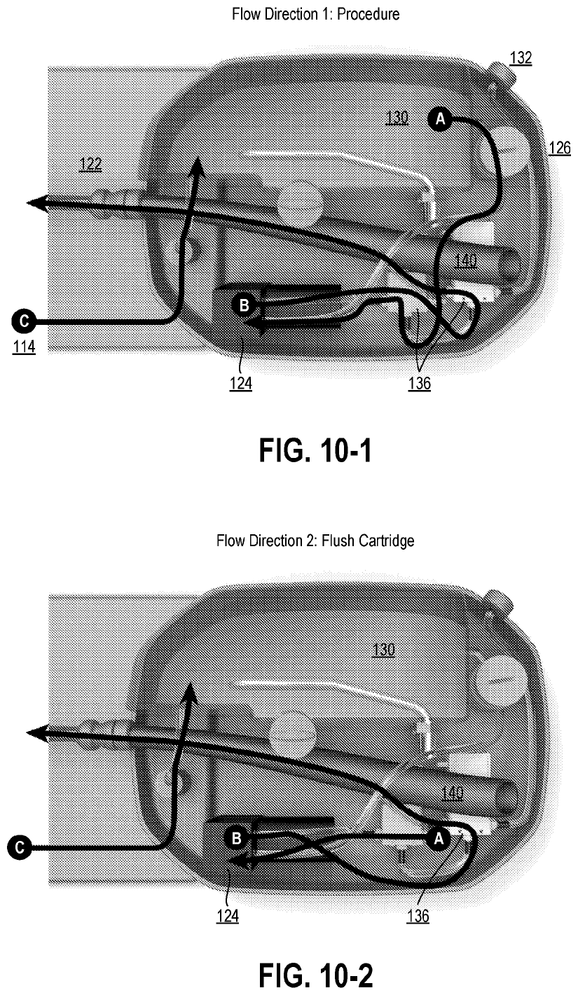

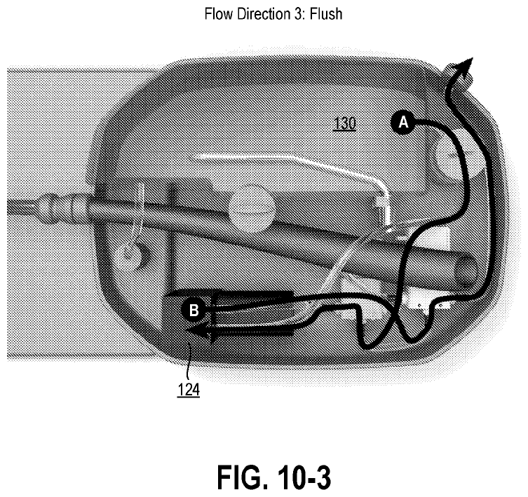

FIG. 10-1 is a top-down cutaway view of a housing showing fluid pathways through the housing. A pump 124 may draw a blood mimicking fluid from a tank 130 for storing the blood mimicking fluid. The blood mimicking fluid may follow a first pathway A. In some embodiments, the blood mimicking fluid may pass through a filter 126 and/or a solenoid valve 136. The blood mimicking fluid may exit the pump 124, following an approach line B, pass through a solenoid valve 136, and into an approach 140. The blood mimicking fluid may then pass through the anatomical cartridges before returning to the tank 130 through a return path C.

In FIG. 10-2, the blood mimicking fluid may be flushed from the pump. For example, the solenoid valve 136 may be closed, and the pump 124 may pull the fluid from the lines between the solenoid valve 136 and the pump 124, according to fluid path A. The pump 124 may push the fluid through fluid path B into the approach 140. The fluid may then be returned to the tank 130 through the fluid path C. In FIG. 10-3, the pump may pump fluid from the tank 130 out of a drain port 132 to flush the housing.

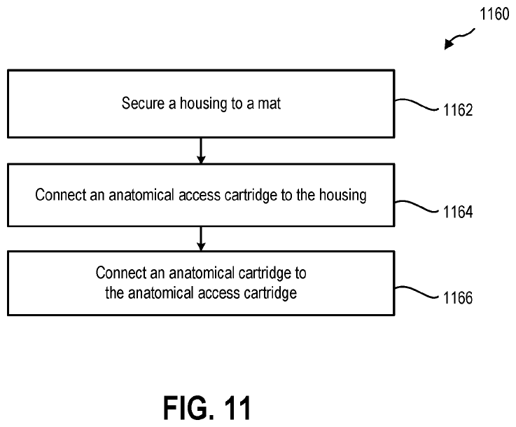

FIG. 11 is a flowchart of a method 1160 for assembling a surgical training and rehearsal system. The method 1160 may include securing a housing to a mat at 1162. As discussed herein, the housing and the mat may include complementary recesses and studs. The recesses and studs may connect the housing to the mat such that the housing may not rotate with respect to the mat. In some embodiments, the recesses and studs may connect fluid lines, such as a return line, to the housing.

A user may an anatomical access cartridge to the housing at 1164. For example, as discussed herein, the user may connect the anatomical access cartridge to an approach located in the housing. The user may connect the anatomical access cartridge to the housing with any type of connection, such as a magnetic connection, a threaded connection, a bolted connection, a press-fit connection, a quick-connect, any other type of connection, and combinations thereof.

An anatomical cartridge may be connected to the anatomical access cartridge at 1166. The user may connect the anatomical access cartridge to the housing with any type of connection, such as a magnetic connection, a threaded connection, a bolted connection, a press-fit connection, a quick-connect, any other type of connection, and combinations thereof.

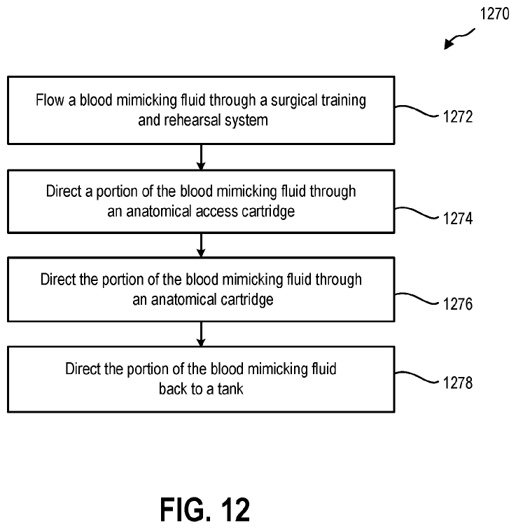

FIG. 12 is a flowchart of a method 1170 for operating a surgical training and rehearsal system, according to at least one embodiment of the present disclosure. The method 1170 may including flowing a blood mimicking fluid through a surgical training and rehearsal system at 1172. For example, a pump may pump a portion of the blood mimicking fluid from a tank for storing the fluid into an approach. The portion of the blood mimicking fluid may be directed to and through an anatomical access cartridge from the approach at 1174.

In some embodiments, the portion of the blood mimicking fluid may be directed to an anatomical cartridge from the anatomical access cartridge at 1176. The blood mimicking fluid may be directed through the anatomical cartridge and directed back to the tank for storing the fluid at 1178.

In some embodiments, the method 1170 may further include injecting one or more blood clots into the surgical training and rehearsal system. For example, the blood clots may be inserted at the anatomical access cartridge. In some examples, the blood clots may be inserted at the anatomical cartridge. In some embodiments, the blood clots may be injected using a syringe. This may allow the user to mimic the presence of blood clots in a patients arteries.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A surgical training and rehearsal system, comprising:
a valve;
a pump fluidically coupled with the valve;
a tank for storing a fluid, the tank fluidically coupled with the valve;
a surgical approach tube having an end covered by self-healing membrane, the surgical approach tube being fluidically coupled with the valve;
an exit port fluidically coupled with a distal end of the surgical approach tube;
an anatomical access cartridge removably coupled with the exit port, the anatomical access cartridge comprising a first tortuous path; and
an anatomical cartridge removably coupled with the anatomical access cartridge, the anatomical cartridge comprising a second tortuous path.

2. The surgical training and rehearsal system of claim 1, further comprising:
a first filter fluidically coupled with the anatomical cartridge to allow fluid exiting the anatomical cartridge to flow through a second filter; and
a return path fluidically coupling the second filter with the tank.

3. The surgical training and rehearsal system of claim 2, further comprising a window for viewing a content of the first filter.

4. The surgical training and rehearsal system of claim 3, wherein the window is transparent and includes a magnifying lens.

5. The surgical training and rehearsal system of claim 2, further comprising:
a mat; and
a housing connected to the mat, one or more of the valve, the pump, the tank and the surgical approach tube being located in the housing, wherein the return path is at least partially located within the mat.

6. The surgical training and rehearsal system of claim 5, wherein one of the housing and the mat includes a first stud and the other of the housing and the mat includes a first recess configured to engage with the first stud, wherein the first stud and the first recess fluidically couple the tank to the return path.

7. The surgical training and rehearsal system of claim 6, wherein one of the housing and the mat is includes a second stud and the other of the housing and the mat includes a second recess configured to engage with the second stud, wherein the second stud and the second recess prevent the housing from rotating with respect to the mat.

8. The surgical training and rehearsal system of claim 7, further comprising a heater within the tank.

9. The surgical training and rehearsal system of claim 5, further comprising a second filter fluidically coupled with the valve, the second filter located within the housing.

10. The surgical training and rehearsal system of claim 5, wherein the housing, mat, anatomical cartridge, and anatomical access cartridge are formed of materials which are compatible with X-ray and fluoroscopy.

11. The surgical training and rehearsal system of claim 1, further comprising a drain port fluidically connected to the valve and the tank.

12. The surgical training and rehearsal system of claim 1, wherein the valve comprises a first valve and a second valves.

13. The surgical training and rehearsal system of claim 5, wherein at least one of the anatomical cartridge and the mat include a first magnet and the other of the anatomical cartridge and the mat include a material magnetically attracted to the first magnet.

14. The surgical training and rehearsal system of claim 5, wherein at least one of the anatomical access cartridge and the mat include a second magnet and the other of the anatomical cartridge and the mat include a material magnetically attracted to the second magnet.

15. The surgical training and rehearsal system of claim 2, further comprising a clot insertion port connected to the anatomical cartridge and configured to insert a clot into the anatomical cartridge.

16. The surgical training and rehearsal system of claim 2, further comprising a clot cartridge connected to the anatomical access cartridge and configured to insert a clot into the anatomical access cartridge.

17. The surgical training and rehearsal system of claim 1, wherein the anatomical access cartridge has at least one of a shape, a size, or mechanical properties that mimic those of a human blood vessel selected from an aortic arch, a radial artery, or a femoral artery.

18. The surgical training and rehearsal system of claim 1, wherein the anatomical cartridge has at least one of a shape, a size, or mechanical properties that mimic those of a human blood vessel selected from a group subclavian artery, a common carotid artery, and a cerebral artery.

19. A surgical training and rehearsal system, comprising:
a housing, including a surgical approach tube having an end covered by self-healing membrane, the surgical approach tube including a port at a distal end;
an anatomical access cartridge removably coupled with the port, the anatomical access cartridge comprising a first tortuous path; and
an anatomical cartridge removably coupled with the anatomical access cartridge, the anatomical cartridge comprising a second tortuous path.

20. A surgical training and rehearsal system, comprising:
a housing, including a surgical approach tube having an end covered by self-healing membrane, the surgical approach tube including a port at a distal end;
an anatomical access cartridge removably coupled with the port, the anatomical access cartridge mimicking a first vasculature; and
an anatomical cartridge removably coupled with the anatomical access cartridge, the anatomical cartridge mimicking a second vasculature.
